(19) United States
(12) Patent Application Publication
(10) Pub. No.: US 2012/0289112 A1
(43) Pub. Date: Nov. 15, 2012

(54) CARBON NANOTUBE REINFORCED ADHESIVE

(75) Inventors: DONGSHENG MAO, Austin, TX (US); ZVI YANIV, Austin, TX (US); TOM JACOB RAKOWSKI, Austin, TX (US)

(73) Assignee: APPLIED NANOTECH HOLDINGS, INC., Austin, TX (US)

(21) Appl. No.: 13/525,801

(22) Filed: Jun. 18, 2012

Related U.S. Application Data
(63) Continuation-in-part of application No. 13/040,085, filed on Mar. 3, 2011.
Application No. 13/040,085 is a continuation-in-part of application No. 11/757,272, filed on Jun. 1, 2007, now abandoned.
Application No. 11/757,272 is a continuation-in-part of application No. 11/693,454, filed on Mar. 29, 2007, now Pat. No. 8,129,463.
Application No. 11/757,272 is a continuation-in-part of application No. 11/695,877, filed on Apr. 3, 2007, now abandoned.
(60) Provisional application No. 60/819,319, filed on Jul. 7, 2006.
(60) Provisional application No. 60/810,394, filed on Jun. 2, 2006.
(60) Provisional application No. 60/788,234, filed on Mar. 31, 2006.
(60) Provisional application No. 60/810,394, filed on Jun. 2, 2006.
(60) Provisional application No. 60/789,300, filed on Apr. 5, 2006.
(60) Provisional application No. 60/810,394, filed on Jun. 2, 2006.

(51) Int. Cl. C09J 163/02; B32B 5/16; C09J 7/04; B82Y 30/00

(52) U.S. Cl. 442/72; 442/149; 523/468; 525/533; 525/523; 977/783; 977/742; 977/750; 977/752

(57) ABSTRACT

Improved mechanical properties of carbon nanotube (CNT)-reinforced polymer adhesive matrix nanocomposites are obtained by functionalizing the CNTs with a compound that bonds well to an epoxy matrix. The particles sufficiently improve mechanical properties of the nanocomposites, such as flexural strength and modulus.

### CROSS-REFERENCE TO RELATED APPLICATIONS

This application for patent is a continuation-impart application of U.S. patent application Ser. No. 13/040,085, which is a continuation-in-part application of U.S. patent application Ser. No. 11/757,272, which claims priority to U.S. Provisional Patent Application Ser. Nos. 60/819,319 and 60/810,394, and which is a continuation-in-part of U.S. patent application Ser. No. 11/693,454, which claims priority to U.S. Provisional Application Ser. Nos. 60/788,234 and 60/810,394, and which is a continuation-in-part of U.S. patent application Ser. No. 11/695,877, which claims priority to U.S. Provisional Application Ser. Nos. 60/789,300 and 60/810,394, all of which are hereby incorporated by reference herein.

### TECHNICAL FIELD

The present invention relates in general to composite materials, and in particular, to composite materials that include carbon nanotubes.

### BACKGROUND AND SUMMARY

Adhesive bonding is a material joining process in which an adhesive, placed between the adhered surfaces, solidifies to produce an adhesive bond. Adhesively bonded joints are increasingly utilized alternatives to mechanical joints in engineering applications and provide many advantages over conventional mechanical fasteners. Among these advantages are lower structural weight, lower fabrication cost, and improved damage tolerance. The application of these joints in structural components made of fiber-reinforced composites has increased significantly in recent years (see, F. Matthews et al., “A review of the strength of joints in fiber-reinforced plastics 2: adhesively bonded joints,” Composites 13(1), pp. 29-37 (1982). which is hereby incorporated by referenced herein). Traditionally used fasteners usually result in the cutting of fibers on fiber-reinforced materials that are fastened together, and hence the introduction of stress concentrations, both of which reduce structural integrity. By contrast, adhesively bonded joints are more continuous and often have advantages of strength-to-weight ratio, design flexibility, and ease of fabrication. In fact, adhesive bonding and repair has found applications in various areas from high technology industries, such as aeronautics, aerospace, electronics, and automotive to traditional industries, such as construction, sports, and packaging (see, M. J. Davis and D. Bond, “Principles and practice of adhesive bonded structural joints and repairs,” hit J. Adhesion Adhes. 19(3), pp. 91-105 (1999), which is hereby incorporated by referenced herein). These applications may be in the form of single ski as well as sandwich configurations. The structures may be made up using different fiber types, fiber architectures and weaves, and resins.

Adhesively bonded joints are frequently expected to sustain static or cyclical loads for considerable periods of capacity of the structure. Safety considerations often require that adhesively bonded structures, particularly those employed in primary load-bearing applications, include mechanical fasteners as an additional safety precaution. However, these practices result in heavier and more costly components. Development of a reliable and strong adhesive can be expected to result in more efficient use of composites. Such an adhesive can be also effectively used to repair cracked, chipped, pierced, and delaminated, composite parts and equipments in the field, which proves to be a lengthy and time consuming endeavor, plus potentially dangerous and expensive as well. Presently, most parts and equipment must be shipped back to the manufacturer or repair facility, which is time consuming and leads to down time; if there is no back-up equipment for the repair, this ultimately leads to a revenue loss, degradation of service and in extreme cases, injury or loss of life such as in a combat setting.

Applications for adhesive bonding and repair include:

A) Sports equipment in the field: cycling, golf, camping, motor sports, etc.

B) Repair centers: hike shops, motor shops, etc.

C) Outdoor electronic housings: radar systems, chem-bio sensors, radiation sensors, scanning systems, directed communication devices, camera housings, etc.

D) Fixed high elevation systems (e.g., difficult to reach and replace): antenna towers, beacon systems, etc.

E) Marine environments

F) Manufacturing and other commercial settings

G) Building and construction environments

H) Consumer general household repairs

I) Military settings, border control, high risk environments

J) Medical environment, laboratory, and research facilities.

As can be appreciated, there is hardly any environment where this application cannot be utilized. Having a quick and easy way to make a repair involving a material that will correspond to any shape and then harden once cured, with the added bonus of being a carbon nanotube (CNT) reinforced adhesive for superior strength and wear resistance, provides many advantages.

Nanocomposites are composite materials that contain nanoparticles (e.g., in the size range of 1-100 nm). These materials bring into play the submicron structural properties of molecules. These particles such as clay and carbon nanotubes (CNTs)) generally have excellent advantageous properties over their bulk, such as a high aspect ratio and/or a layered structure that maximizes bonding between the polymer and particles. Adding a small quantity of these additives (e.g., 0.5-5%) often increases many of the properties of polymer materials (such as higher strength, greater rigidity, higher heat resistance, higher ultraviolet (UV) resistance, lower water absorption rate, lower gas permeation rate, and other improved properties) (see, T. D. Fornes et al., “Nylon-6 nanocomposites from Alkylammonium-modified clay: The role of Alkyl tails on exfoliation,” Macromolecules 37, pp. 1.791-1798 (2004), which is hereby incorporated by reference herein).

### BRIEF DESCRIPTION OF THE DRAWINGS

FIG. 1 illustrates an SEM image of NH₂-functionalized DWNTs.

FIG. 2 illustrates NH₂-DWNT/acetone solution dispersed by a microfluidic process (left) and ultrasonication (right).

FIG. 3 illustrates a process flow to manufacture epoxy/CNT nanocomposites.

FIG. 4 illustrates a flexural surface of a MWNT-reinforced epoxy nanocomposite: (left) COOH-MWNT (1.5 wt. %) and (right) non-functionalized MWNT (1.5 wt. %).

FIG. 5 illustrates exemplary joint configurations for epoxy adhesives used for bonding composite materials.

FIG. 6 shows a graph of improved adhesive shear strength.

### DETAILED. DESCRIPTION

Since their first observation by Iijima in 1991, CNTs have been the focus of considerable research (see, S. Iijima, “Helical microtubules of graphitic carbon,” Nature 354, 56 (1991), which is hereby incorporated by reference herein). Many investigators have reported the remarkable physical and mechanical properties of this new form of carbon, from unique electronic properties and a thermal conductivity higher than that of diamond, to mechanical properties where the stiffness, strength, and resilience exceeding that of any current material. CNTs typically are 0.5-1.5 nm in diameter for single wall CNTs (SWNTs), 1-3 nm in diameter for double wall CNTs (DWNTs), and 5 nm to 100 nm in diameter for multi-wall CNTs (MWNTs). In particular, the exceptional mechanical properties of CNTs (e.g., E>1.0 TPa and tensile strength of 50 GPa) combined with their low density (e.g, 1-2.0 g/cm³) provide advantages for CNT-reinforced composite materials (see, Eric W. Wong et al., “Nanobeam Mechanics: Elasticity, Strength, and Toughness of Nanorods and Nanotubes,” Science 277, 1971 (1997), which is incorporated by reference herein). CNTs are the strongest material known on earth. Compared with MWNTs, SWNTs and DWNTs may be better as reinforcing materials for composites because of their higher surface area and higher aspect ratio. Table 1 lists exemplary surface areas and aspect ratios of SWNTs, DWNTs, and MWNTs.

TABLE 1

| CNTs | SWNTs | DWNTs | MWNTs |
|---|---|---|---|
| Surface area (m²/g) | 300-600 | 300-400 | 40-300 |
| Geometric aspect ratio | ~10,000 | ~5,000 | ~100-1000 |
| (length/diameter) | | | |

Epoxy adhesives may be utilized for joint bonding and repair. By using CNT reinforcement, the epoxy adhesives achieve significantly improved strength, such as shear and peel strength and wear resistance. For the commercial price, MWNTs are preferred for use in the epoxy adhesive matrix. However, DWNTs, SWNTs, or a combination of different types of the CNTs may be also used for reinforcing the properties of the epoxy adhesives. The CNTs may be pristine (not functionalized), or they maybe functionalized with functional groups (such as COOH, NH₂, OH) to improve the bonding between the CNTs and epoxy matrix in order to further improve the properties of the epoxy adhesive matrix.

The CNTs may be mixed with an epoxy adhesive matrix via mechanical stirring, grinding, ball milling, shear mixing, sonication, or other ways that lead to dispersing CNTs in the epoxy adhesive matrix.

Except for the epoxies, other thermosets that may be used as described herein include, but are not limited to, acrylics, phenolics, cyanate esters, bismaleimides, polyimides, polyurethanes, silicones, or any combination thereof. Embodiments of the present invention improve mechanical properties of CNT-reinforced polymer matrix nanocomposites by utilizing the following steps:

1. Functionalize the CNTs on their surface so that they form a strong bond with the epoxy adhesive matrix;

2. Disperse the functionalized CNTs in an epoxy resin (e.g., using a microfluidic dispersion process) to form an excellent dispersion of the functionalized CNTs in the epoxy matrix.

The following examples are described.

Epoxy adhesive, hardener, double-wall CNTs (DWNTS), and multi-wall CNTs (MWNTS):

DWNTs were commercially obtained from Nanocyl, Inc., Namur, Belgium (Nanocyl-2100 product series). The DWNTs had an average outer diameter of 3.5 nm and lengths of approximately 1-10 μm. The DWNTs were produced via a catalytic carbon vapor deposition (CCVD) process, though other processes could be utilized. CNTs collected from the reactor were then purified to greater than 90% carbon by the manufacturer. MWNTs were commercially obtained from Mitsui Co., Japan and other commercial vendors. The MWNTs were highly purified (e.g., >95% purity). Epon 828 epoxy resin and a hardener (dicyandiamide) used to cure the epoxy were commercially obtained from Mitsubishi Corporation, Japan.

Functionalization of DWNTs and MWNTs:

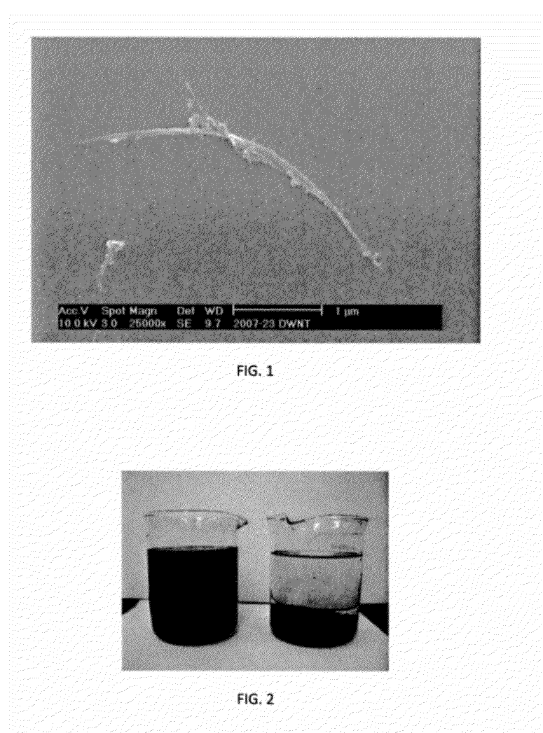

The purified DWNTs and MWNTs were put through an oxidation process by placing them in a 3:1 HNO₃/H₂SO₄ solution. The DWNTs and MWNTs in the solution were sonicated in an ultrasonic bath flow. The oxidation process resulted in functionalization of the DWNTs and MWNTs with a carboxylic functional group (—COOH) on the CNT surfaces. The CNTs were cleaned (e.g., using de-ionized water) and filtered (e.g., using a 2 μm mesh Teflon thin film filter under a vacuum). The CNTs collected from the Teflon thin film were dried (e.g., under vacuum) in preparation for epoxy nanocomposite fabrication. The COOH-functionalized DWNTs were further functionalized with a NH₂— group (e.g., utilizing a wet chemical process) (see, Z. Konya et al., Chemical Physics Letters 360, 429 (2002), which is incorporated herein by reference). FIG. 1 shows an SEM image of NH₂-functionalized DWNTs illustrating the relative high roughness of the DWNT's surfaces.

Dispersion of CNTs:

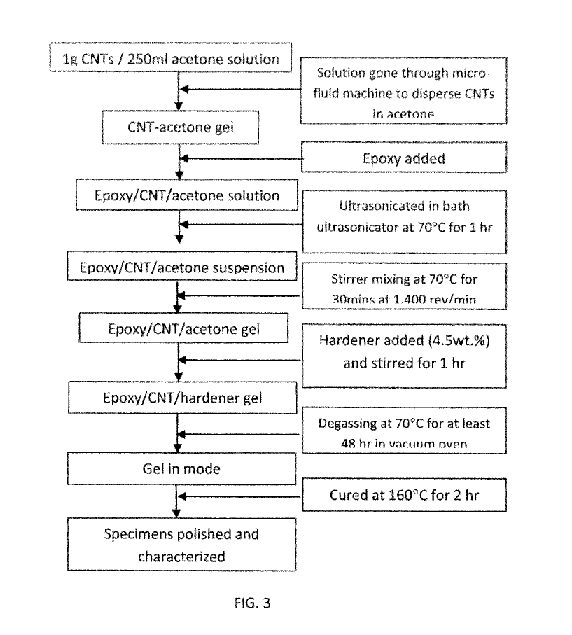

Referring to FIG. 3, a readily reproducible microfluidic process for achieving highly homogeneous dispersions of CNTs may be utilized. The microfluidic machine may be purchased from Microfluidics Corp., Newton, Mass., (Microfluidizer® Model 110Y, serial 2005006E), which uses high-pressure streams that collide at ultra-high velocities in precisely defined micron-sized channels. Its combined forces of shear and impact act upon products to create uniform dispersions. CNT dispersions may be prepared utilizing the microfluidizer processor to generate high shear forces in the dispersion to effectively break up CNT ropes and bundles. In step 301. CNTs were mixed with acetone and dispersed in step 302 (e.g., using the microfluidic processor at an elevated pressure). After dispersion, well-dispersed mixtures of CNTs in the acetone solvent manifest themselves as a gel (step 303). FIG. 2 shows a picture of NH₂-DWNTs in acetone solution dispersed by the microfluidic process compared to a dispersion by an ultrasonic horn (a traditional method used to disperse CNTs) one hour after the dispersion process (0.5 g NH₂-DWNTs in 200 ml acetone in each glass beaker). The higher quality of the dispersions is observed.

Sample Preparation for Mechanical Properties Evaluation:

Epon 828 resin was then added in step 304 in the CNT/acetone gel at ratios needed for sample preparation (step 305). In step 306, the mixing process may use a stirrer at approximately 70° C. for half an hour at a speed of 1000 rev/min to produce a suspension on (step 307) followed by an ultrasonication process in step 308 to evaporate the acetone and disperse the DWNTs in the epoxy matrix (step 309). The hardener (dicyandiamide) may then be added in step 310 into the mixture (e.g., at a ratio of 4.5 wt. %) and mixed by stirring (e.g., at 70° C. for 1 hour) to produce an epoxy/CNT/hardener gel (step 311). The mixture may be degassed in step 312 (e.g., in a vacuum oven at approximately 70° C. for 2-48 hours). In step 313, the mixture was then poured into a release agent-coated Teflon mold and cured (e.g., at 160° C. for 2 hours) in step 314. The specimens may be polished in step 315 (e.g., using fine sandpaper) to create flat and smooth surfaces for ASTM evaluation.

In this example, neat, non-functionalized, COOH-functionalized DWNTs, COOH-functionalized MWNTs, and NH₂-functionalized DWNT reinforced epoxy nanocomposites were synthesized for comparison.

Characterization:

An MTS Servo Hydraulic test system (capacity 22 kips) used for 3-point bending testing for flexural strength and modulus evaluation (based on ASTM D790). It was also used for compression strength testing (ASTM E9). Impact strength was tested based on ASTM D256. Vibration damping was tested based on ASTM E756.

A Hitachi S4800 FEI XL50 High Resolution SEM/STEM system was used for SEM imaging of the fracture surfaces of both reinforced epoxy nanocomposites.

Results:

Table 2 shows mechanical properties of the CNT-reinforced both DWNT an MWNT) epoxy nanocomposites compared with an epoxy neat sample.

TABLE 2

| | Compression | Flexural | Flexural | Impact | |
|---|---|---|---|---|---|
| | strength | strength | modulus | strength | Vibration |
| Material | (MPa) | (MPa) | (GPa) | (J/m) | damping |
| Neat Epon 828 | 125 | 116 | 3.18 | 270 | 0.331 |
| DWNT (1.2 wt. %)/Epon 828 | | 120 | 3.56 | | |
| COOH-DWNT (1.2 wt. %)/Epon 828 | | 137 | 3.70 | | |
| NH₂-DWNT(1.2 wt. %)/Epon 828 | | 155 | 3.70 | | 0.466 |
| NH₂-DWNT(0.5 wt. %)/Epon 828 | | 139 | 3.26 | | |
| NH₂-DWNT(1.8 wt. %)/Epon 828 | 172 | 165 | 3.70 | 355 | 0.476 |
| COOH-MWNT (0.5 wt. %)/Epon 828 | 131 | 144 | 3.38 | | |
| COOH-MWNT (0.75 wt. %)/Epon 828 | 138 | 151 | 3.57 | | |
| COOH-MWNT (1.0 wt. %)/Epon 828 | 158 | 159 | 3.61 | | |
| COOH-MWNT (1.25 wt. %)/Epon 828 | 170 | 162 | 3.70 | | |
| COOH-MWNT (1.5 wt. %)/Epon 828 | 180 | 168 | 3.72 | | |
| MWNT (1.5 wt. %)/Epon 828 | 135 | 125 | 3.58 | | |

From the results in Table 2, one concludes that proper functionalization of DWNTs has a great effect on the flexural strength of the epoxy nanocomposites. Compared with the neat epoxy, improvement of flexural strength was 3%, 18%, and 33%, respectively, for the non-functionalized, COOH-functionalized and NH₂-functionalized DWNT-reinforced epoxy nanocomposites at 1.2 wt. % loading. At NH₂-DWNT loading of 1.80 wt. %, compression strength, flexural strength, modulus, impact strength, and vibration damping factors were improved 39%, 42%, 16%, 31%, and 44%, respectively, compared with the neat epoxy. Further improvement may be seen by increasing the loading of the NH₂-DWNTs; however, the viscosity of the epoxy becomes higher with increasing loading of the DWNTs. The heightened viscosity makes higher loading of the CNTs impractical for epoxy nanocomposite fabrication.

The results in Table 2 show that the NH₂-DWNT reinforced epoxy nanocomposite is more effective for the improvement of the mechanical properties of the epoxy matrix than COOH-DWNT reinforced epoxy nanocomposites. NH₂-functional groups located on the surface of the DWNTs react and form covalent bonds with the epoxy matrix, and as a result, significantly enhance the interfacial adhesion. The NH₂-functional groups are terminated at the open end of the DWNTs. As a result, the DWNTs can be integrated easily into the epoxy matrix via a reaction with the epoxy, and consequently become an integral part of the matrix structure (see, J. Zhu et al., Advanced Functional Materials 14, 643 (2004), which is hereby incorporated by reference herein).

As for the COOH-CNT reinforced epoxy nanocomposites, the surfaces of the DWNTs affects the wettability between the surfaces of CNTs and the matrix. It is very possible that the COOH-CNTs are hydrophilic to the epoxy matrix after the functionalization, which improves their dispersion in the epoxy matrix (see, J. Zhu et al., Advanced Functional Materials 14, 643 (2004)). The COOH-functional groups attached onto the CNTs provide for chemical interactions with the epoxy matrix resulting in enhanced mechanical properties.

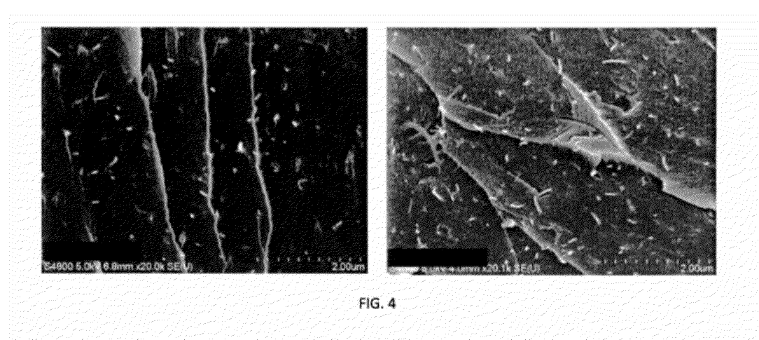

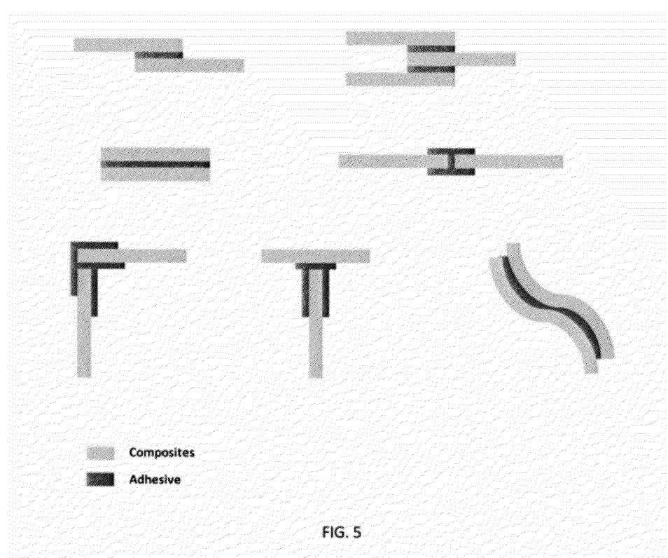

FIG. 4 shows flexural surfaces of both COOH-MWNTs (1.5 wt. %) and non-functionalized MWNTs (1.5 wt.) in an epoxy matrix. In both cases, the CNTs are very well dispersed in the epoxy matrix. However, in the case of the COOH-MWNT (1.5 wt. %) epoxy, fewer and shorter CNTs are observed than with the non-functionalized MWNT (1.5 wt. %) epoxy on the flexural surface. This further confirms that the bonding strength between the COOH-MWNTs and epoxy is much stronger than between the non-functionalized MWNTs and epoxy matrix. The carbon nanotubes are more likely broken than simply pulled out. This also indicates that using functionalized CNTs effectively prevents crack propagation and improves the bonding strength with the substrate material to be bonded.

FIG. 5 illustrates exemplary joint configurations for epoxy adhesives used for bonding composite materials, though the present invention is not limited to bonding or repairing these particular joint configurations. The composite materials to be bonded include, but are not limited to, metals, alloys, ceramics, plastics, fiber-reinforced plastics, or any combination thereof.

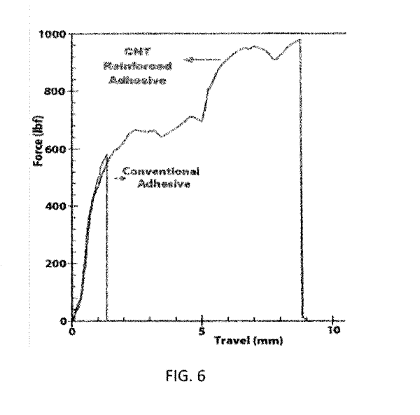

FIG. 6 shows a graph comparing the adhesive shear, or tear, strength of a CNT reinforced epoxy adhesive in accordance with embodiments of the present invention versus an epoxy adhesive not CNT reinforced. This graph shows the results of an ASTM International standard adhesion shear test (C961) conducted by an independent ISO-approved testing lab. The C961 test measures the cohesive strength of sealants when subjected to shear stresses. The graph in FIG. 6 shows that the CNT reinforced epoxy adhesive was able to resist shearing at close to 1,000 pound feet (lbf) of force over approximately 9 millimeters (mm), compared to a leading industry epoxy adhesive not CNT reinforced that sheared at close to 600 lbf of force over less than 2 mm. The CNT reinforced epoxy adhesive possesses at least a 60% improvement in adhesive shear, or tear, strength.

A CNT impregnated carbon fiber epoxy repair kit in accordance with embodiments of the present invention provides a portable tool that allows “on the spot” repair, which can cut down on costs related to equipment downtime and shipping back for repairs; in critical applications, this repair kit can save lives (e.g., combat scenarios where downtime is not an option due to equipment failure).

Such a repair kit may include the following:

a. Instructions

b. CNT prepreg carbon cloth with a high performance adhesive backing

c. Solvent cleaner to increase CNT prepreg adhesion to parts

d. Curing apparatus (easy to use to provide the required temperature and time for a heat reaction).

The CNT prepreg carbon cloth may have an adhesive backing; or the carbon cloth may not have CNT, but instead a CNT epoxy paste applied prior to curing thereby adding the CNT in varying thicknesses where desired; or in certain instances like pipelines and high pressure applications there may be a secondary “barrier,” such as a flexible mesh (e.g., utilizing titanium or other alloys for added strength).

The exemplary joint configurations in FIG. 5 may be repaired with such a kit.

The result is CNT epoxy adhesive repair kit that is easy to use and readily customizable by allowing the operator to cut the carbon CNT sheet to any desired shape for a stated repair. This approach is favorable because it can eliminate the time constraints of sending back equipment for repair. This approach allows the repair to be done “on the fly.” A unique benefit is that the repair kit creates a very strong and structurally solid area.

Tooling:

A first step in making a composite frame for a device (e.g., a bicycle frame) is to create a custom-made steel or alloy mold that defines the outside shape and surfaces of the frame, depending on the part it is being created for.

Layup and Pre-Form:

In this step to the manufacturing process, flexible sheets and pieces of prepreg are wrapped over a pre-form mandrel and assembled into the shape of a frame, fork, or part according to a heavily revised layup schedule development. A pre-form may be anything; a round tube, the nylon bladder used to mold the frame, or even just a piece of wood. In certain cases (e.g., high end bikes), the pre-form shape mimics the shape of the mold cavity as closely as possible. These accurate pre-forms allow the manufacturer to mold very complex shapes and optimize fiber alignment, which can achieve the ultimate in stiffness in a frame.

Next, an air bladder made of pressure-resistant nylon may be placed inside the flexible composite prepreg layup structure. Its function is to internally pressurize the composite prepreg material in the layup against the tooling surface to eliminate internal voids in the composite structure. By using silicone lining in conjunction with the bladder during molding, one can ensure adequate compaction in areas with complex geometry. Still pliable, the entire prepreg assembly, including the bladder, may be placed inside the steel or alloy mold. The multi-piece mold may be closed and locked down, and the bladders connected to pressurized air fittings.

Molding:

The closed mold moves into an electric hot press or oven where its temperature is raised. This raised temperature allows the resin in the prepreg to liquefy and spread uniformly in the composite layup. To help aid in the process, the bladders inside the prepreg assembly may be pressurized (e.g., approximately 100-150 psi). This mixing of resin in the carbon fabric is referred to as “wet out,” an important component for the integrity of the molded structure. Too little pressure in the bladder and the composite will not wet out effectively, leaving high-resin areas that add useless weight and low-resin areas that weaken the structure. Too much pressure and the resin may be squeezed out of the composite. Correct wet out pressure forces (e.g. between 4% and 8%) the resin out of the prepreg. The mold may remain at this temperature for about 30 minutes depending on its size, then it is cooled down. Due to the size and mass of the steel or alloy tooling, this may require another 20-30 minutes. Once the frame inside the mold has sufficiently cooled, the resin is cured.

What is claimed is:

1. An adhesive material comprising a mixture of a thermoset and carbon nanotubes bonding composites.

2. The adhesive material as recited in claim 1, wherein the thermoset is an epoxy.

3. The adhesive material as recited in claim 1, wherein a content of the carbon nanotubes in the adhesive material is in a range of 0.1 wt. % to 10 wt. %.

4. The adhesive material as recited in claim 1, wherein the carbon nanotubes are single wall carbon nanotubes.

5. The adhesive material as recited in claim 1, wherein the carbon nanotubes are double wall carbon nanotubes.

6. The adhesive material as recited in claim 1, wherein the carbon nanotubes are multi-wall carbon nanotubes.

7. The adhesive material recited in claim 1, wherein the carbon nanotubes are not functionalized.

8. The adhesive material as recited in claim 1, wherein the carbon nanotubes are functionalized with COOH-functional groups.

9. The adhesive material as recited in claim 1, wherein the carbon nanotubes are functionalized with NH2-functional groups.

10. The adhesive material as recited in claim 1, wherein the carbon nanotubes are functionalized with OH-functional groups.

11. The adhesive material as recited in claim 1, wherein the composites are metals.

12. The adhesive material as recited in claim 1, wherein the composites are alloys.

13. The adhesive material as recited in claim 1, wherein the composites are plastics.

14. The adhesive material as recited in claim 1, wherein the composites are fiber-reinforced plastics.

15. The adhesive material as recited in claim 14, wherein fiber in the fiber-reinforced plastics is carbon fiber.

16. The adhesive material as recited in claim 14, wherein a fiber in the fiber-reinforced plastics is glass fiber.

17. The adhesive material as recited in claim 14, wherein a fiber in the fiber-reinforced plastics is synthetic fiber.

18. The adhesive material as recited in claim 1, wherein the carbon nanotubes comprise two or more of single wall, double wall, and multi-wall carbon nanotubes.

19. The adhesive material as recited in claim 1, further comprising a prepreg carbon cloth.

20. The adhesive material as recited in claim 19, wherein the prepreg carbon cloth is impregnated with carbon nanotubes.
